(19) United States
(12) Patent Application Publication
(10) Pub. No.: US 2013/0286317 A1
(43) Pub. Date: Oct. 31, 2013

(54) Liquid Crystal Medium Composition, Liquid Crystal Display Using Same and Manufacturing Method Thereof

(71) Applicant: Xinhui Zhong, Shenzhen City (CN)

(72) Inventor: Xinhui Zhong, Shenzhen City (CN)

(73) Assignee: Shenzhen China Star Optoelectronics Technology Co. LTD., Shenzhen City, Guangdong (CN)

(21) Appl. No.: 13/516,718

(22) PCT Filed: May 10, 2012
(86) PCT No.: PCT/CN12/75267

§ 371 Date: Jun. 15, 2012

(30) Foreign Application Priority Data
Apr. 28, 2012 (CN) 201210132934.1

(51) Int. Cl. C09K 19/54

(52) U.S. Cl. CPC C09K 19/54
USPC 349/56; 252/299.01; 252/299.5; 252/299.63; 252/299.66; 349/182; 349/187; 445/24

(57) ABSTRACT

The present invention provides a liquid crystal medium composition, a liquid crystal display using same and a manufacturing method thereof. The liquid crystal medium composition includes a liquid crystal material, a polymerizable monomer, a stabilizer, and a sensitizer. The sensitizer shows strong absorbance of ultraviolet light having wavelength between 300-380 nm and is composed of a polycyclic aromatic hydrocarbon composed of a plurality of benzene rings linked with substituted moieties. The liquid crystal display includes: upper and a lower substrate that are arranged parallel to each other and the liquid crystal medium composition arranged between the upper and lower substrates. The present invention includes a sensitizer that shows strong absorbance of ultraviolet light of wavelength 300-380 nm so as to make reactive wavelength of the polymerizable monomer shifted toward a longer wavelength, thereby avoiding the absorption band of the liquid crystal material and alleviating damage caused by ultraviolet light.

### BACKGROUND OF THE INVENTION

1. Field of the Invention

The present invention relates to the field of liquid crystal displaying techniques, and in particular to a liquid crystal medium composition, a liquid crystal display (LCD) using same and a manufacturing method thereof.

2. The Related Arts

In the business of LCD, the recently developed PSVA (Polymer Stabilized Vertical Alignment) technique shows various advantages, such as wide viewable angle, high contrast, and fast response, over the traditional twisted nematic (TN) and super twisted nematic (STn) techniques. As compared to other VA (Vertical Alignment) techniques, such as MVA (Multi-domain Vertical Alignment) and PVA (Patterned Vertical Alignment), PSVA shows advantages in respect of transmittance and simplified process. As a result, PSVA is the current main stream of the contemporary TFT-LCD business.

In a key process of manufacturing of PSVA, a negative liquid crystal material is used. When no electric field is applied, liquid crystal molecules are arranged in such a way of being substantially perpendicular to a substrate surface. A certain amount of monomer, which when irradiated by ultraviolet light, carries out a polymerization reaction, is added to the liquid crystal material, and this is referred to as reactive mesogen (RM). After an assembling operation is performed by having liquid crystal dropping onto a substrate, a signal having proper frequency, waveform, or voltage is applied to the panel to cause the liquid crystal molecules to tilt in a predetermined direction. Meanwhile, ultraviolet light is applied to irradiate the panel to cause the RM polymerized and forming a polymer deposited on two substrate surfaces inside the panel. This deposition is referred to as polymer bumps, which provide the liquid crystal molecules with a pre-tilt angle with no voltage applied thereto. This helps increasing the response speed of the liquid crystal molecules. Relative rubbing effects alignment only in a specific direction, but the method in question is advantageous in that various angle alignment (generating pre-tilt angles 0 in different domains of a panel can be realized.

According to the disclosure of U.S. Pat. No. 7,169,449, photo reactive groups contained in the reactive mesogens used in PSVA technique are usually methacrylate, acrylate, ethenyl, ethyleneoxy or epoxy groups, among which methacrylate is the most commonly used one. However, there are problems caused by directly irradiating ultraviolet light to induce reaction of the reactive mesogens. The primary range of wavelength that is applied to cause photo-polymerization of the reactive mesogens of these functional groups is 200-300 nm. Although such reaction of reactive mesogens may occur for ultraviolet light having a wavelength greater than 300 nm, yet the efficiency is extremely poor and the speed is low, making it poor in mass productivity. Consequently, it is necessary to use a light having a wavelength less than 300 nm to irradiate a panel for causing reaction of the liquid crystal material. However, a number of drawbacks and difficulties may be caused for the manufacture of panels if light of a wavelength less than 300 nm is used. Firstly, an ultraviolet light having a wavelength less than 300 nm has higher energy, which may cause degradation and damage of polyimide that makes an alignment layer and liquid crystal molecules, leading to reduced VHR (Voltage Holding Ratio) of the panel, severe image sticking, and worsened result of reliability analysis (RA). Secondly, a glass plate that is used to form a TFT-LCD substrate shows certain absorption of ultraviolet lights having wavelength less than 300 nm, causing deterioration of light irradiation efficiency. It is even worse that the liquid crystal material itself shows strong absorption of ultraviolet light having a wavelength less than 300 nm. Ultraviolet light having a wavelength less than 300 nm is generally completely blocked from transmitting through the liquid crystal material. In other words, most of the ultraviolet light emitting from a light source is absorbed by the liquid crystal material (causing damage) and only a minor portion of the ultraviolet is absorbed by the reactive mesogens to induce polymerization reaction. This occurs in a very shallow position at the light incidence side. This will cause inhomogeneous reaction of reactive mesogens between the light incidence side and the opposite back side, leading to worsened alignment effect of the panel.

### SUMMARY OF THE INVENTION

An object of the present invention is to provide a liquid crystal medium composition, which is added with a sensitizer that has strong absorption of ultraviolet light having a wavelength ranging from 300-380 nm, whereby with the sensitizer, reactive wavelength of a polymerizable monomer is shifted toward a longer wavelength, making the efficiency of polymerization heightened and homogeneity of polymer so formed improved.

Another object of the present invention is to provide a liquid crystal display and a manufacturing method thereof, wherein through adoption of the above discussed liquid crystal medium composition that can be irradiated by ultraviolet light of wavelength ranging from 300-380 nm, absorption wavelength band can be avoided, damage to the liquid crystal material and the alignment material of polyimide can be reduced, efficiency and homogeneity of reaction of the polymerizable monomer can be heightened, the alignment effect of panel can be improved, and thus the quality and lifespan of the panel are enhanced.

To achieve the objects, the present invention provides a liquid crystal medium composition, which comprises: a liquid crystal material, a polymerizable monomer, a stabilizer, and a sensitizer, wherein the sensitizer shows strong absorbance of ultraviolet light having wavelength between 300-380 nm and is composed of a polycyclic aromatic hydrocarbon composed of a plurality of benzene rings linked with substituted moieties.

The sensitizer comprises at least one represented by the following formulas:

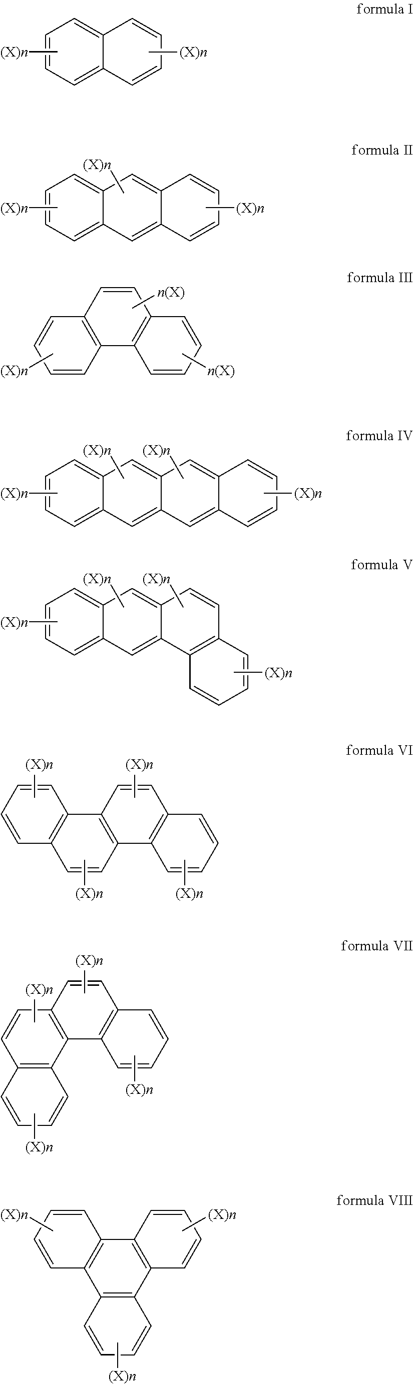

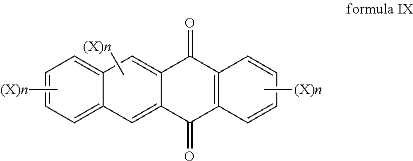

wherein X represents the substituted moieties linked to the rings; n is an integral of 1-4; n values in any of the above formulas are identical or different; n>1 indicates the individual ring structure has a plurality of substituted moieties X which are identical or different; the substituted moiety represented by X is: —H, —F, —Cl, —Br, —I, —CN, —NO₂, —R, —O—R, —CO—R, —OCO—R, —COO—R, or —(OCH₂CH₂)ₙ₁CH₃; R represents a C1-12 linear or branched alkyl; and n1 is an integral of 1-5.

The sensitizer is added in an amount of 5 ppm to 1000 ppm based on the total weight of the liquid crystal medium composition.

The polymerizable monomer contained in the liquid crystal medium composition is polymerized through the sensitizer by means of irradiation of ultraviolet light having a wavelength of 300-380 nm.

The liquid crystal material comprises at least one liquid crystal molecule represented by the following formula:

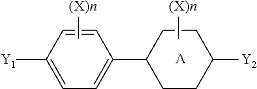

wherein

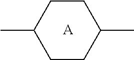

represents

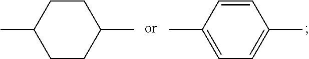

X represents substituted moieties linked to the rings, n is an integral of 1-4; n values in any of the above formulas are identical or different; n>1 indicates the individual ring structure has a plurality of substituted moieties X which are identical or different; the substituted moiety represented by X is: —H, —F, —Cl, —Br, —I, —CN, or —NO₂; Y₁ and Y₂ are —R, —O—R, —CO—R, —OCO—R, —COO—R, or —(OCH₂CH₂)ₙ₁CH₃; R represents a C1-12 linear or branched alkyl; n1 is an integral of 1-5; and Y₁ and Y₂ are identical or different.

The polymerizable monomer comprises at least one polymerizable molecule represented by the following formula:

P₁-L₁-X-L₂-P₂

wherein P₁ and P₂ represent polymerizable moieties which, being identical or different, are methacrylate, acrylate, ethenyl, ethyleneoxy, or epoxy groups; L₁ and L₂ represent linking moieties which, being identical or different, are —C—C—, —O—, —COO—, —OCO—, —CH₂O—, —OCH₂O—, —O(CH₂)₂O—, —COCH₂—, or methylenyl; X represents a core moiety which is

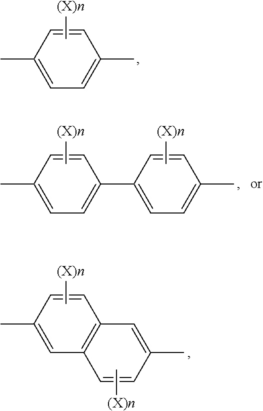

wherein X represents a substituted moiety linked to the ring structure; n is an integral of 1-4; n values in any of the above formulas are identical or different; n>1 indicates the individual ring structure has a plurality of substituted moieties X which are identical or different; the substituted moiety represented by X is: —H, —F, —Cl, —Br, —I, —CN, or —NO₂.

The stabilizer comprises at least one molecule represented by the following formula:

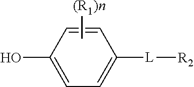

wherein R₁ represents a C1-9 linear or branched alkyl; n is an integral of 1-4; n>1 indicates the individual ring structure has a plurality of substituted moieties R₁ which are identical or different; R₂ represents a C1-36 linear or branched alkyl; and L is —C—C—, —O—, —COO—, —OCO—, —CH₂O—, —OCH₂O—, —O(CH₂)₂O—, —COCH₂— or methylenyl.

The present invention also provides a liquid crystal display, which comprises: upper and a lower substrate that are arranged parallel to each other and a liquid crystal medium composition arranged between the upper and lower substrates. The liquid crystal medium composition comprises: a liquid crystal material, a polymerizable monomer, a stabilizer, and a sensitizer, wherein the sensitizer shows strong absorbance of ultraviolet light having wavelength between 300-380 nm and is composed of a polycyclic aromatic hydrocarbon composed of a plurality of benzene rings linked with substituted moieties.

The sensitizer comprises at least one represented by the following formulas:

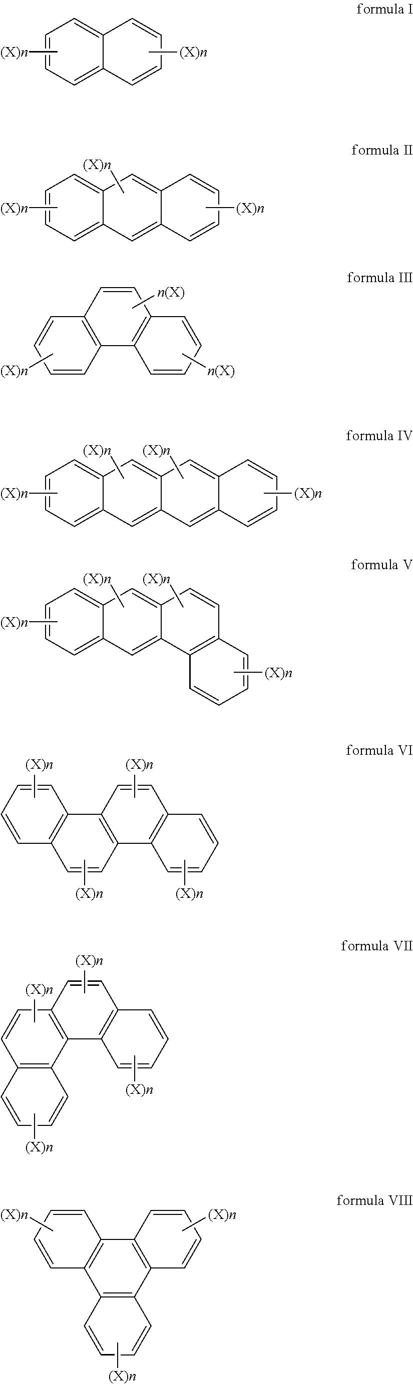

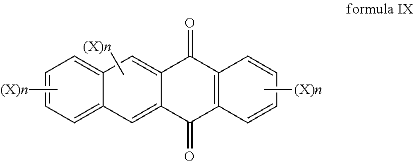

wherein X represents the substituted moieties linked to the rings; n is an integral of 1-4; n values in any of the above formulas are identical or different; n>1 indicates the individual ring structure has a plurality of substituted moieties X which are identical or different; the substituted moiety represented by X is: —H, —F, —Cl, —Br, —I, —CN, —NO₂, —R, —O—R, —CO—R, —OCO—R, —COO—R, or —(OCH₂CH₂)ₙ₁CH₃; R represents a C1-12 linear or branched alkyl; and n1 is an integral of 1-5.

The polymerizable monomer contained in the liquid crystal medium composition is polymerized through the sensitizer by means of irradiation of ultraviolet light having a wavelength of 300-380 nm; and the sensitizer is added in an amount of 5 ppm to 1000 ppm based on the total weight of the liquid crystal medium composition.

The liquid crystal material comprises at least one liquid crystal molecule represented by the following formula:

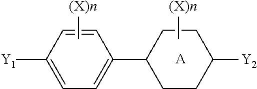

wherein

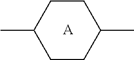

represents

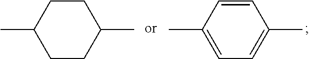

X represents substituted moieties linked to the rings, n is an integral of 1-4; n values in any of the above formulas are identical or different; n>1 indicates the individual ring structure has a plurality of substituted moieties X which are identical or different; the substituted moiety represented by X is: —H, —F, —Cl, —Br, —I, —CN, or —NO₂; Y₁ and Y₂ are —R, —O—R, —CO—R, —OCO—R, —COO—R, or —(OCH₂CH₂)ₙ₁CH₃; R represents a C1-12 linear or branched alkyl; n1 is an integral of 1-5; and Y₁ and Y₂ are identical or different.

The polymerizable monomer comprises at least one polymerizable molecule represented by the following formula:

P₁-L₁-X-L₂-P₂

wherein P₁ and P₂ represent polymerizable moieties which, being identical or different, are methacrylate, acrylate, ethenyl, ethyleneoxy, or epoxy groups; L₁ and L₂ represent linking moieties which, being identical or different, are —C—C—, —O—, —COO—, —OCO—, —CH₂O—, —OCH₂O—, —O(CH₂)₂O—, —COCH₂—, or methylenyl; X represents a core moiety which is

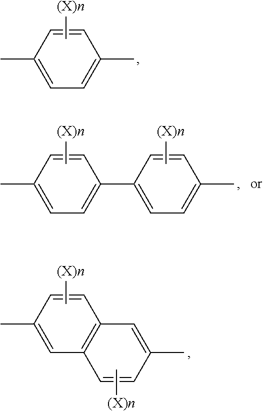

wherein X represents a substituted moiety linked to the ring structure; n is an integral of 1-4; n values in any of the above formulas are identical or different; n>1 indicates the individual ring structure has a plurality of substituted moieties X which are identical or different; the substituted moiety represented by X is: —H, —F, —Cl, —Br, —I, —CN, or —NO₂.

The stabilizer comprises at least one molecule represented by the following formula:

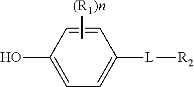

wherein R₁ represents a C1-9 linear or branched alkyl; n is an integral of 1-4; n>1 indicates the individual ring structure has a plurality of substituted moieties R₁ which are identical or different; R₂ represents a C1-36 linear or branched alkyl; and L is —C—C—, —O—, —COO—, —OCO—, —CH₂O—, —OCH₂O—, —O(CH₂)₂O—, —COCH₂— or methylenyl.

The upper substrate comprises an upper glass substrate and a black matrix, R, G, B pixels, substrate spacers, and common electrode formed on a surface thereof that faces the lower substrate. The lower substrate comprises a lower glass substrate and a TFT array, ITO pixel electrodes, and common electrodes formed on a surface thereof that faces the upper substrate. Surfaces of the upper and lower substrates that face each other are coated with alignment films, which are formed of an alignment material of polyimide.

The present invention further provides a method for manufacturing the above discussed liquid crystal display, comprising the following steps:

(1) providing upper and lower substrates and the liquid crystal medium composition;

(2) dropping the liquid crystal medium composition on the lower substrate;

(3) mounting the upper substrate to the lower substrate in a manner of being set in parallel to the lower substrate so as to interpose the liquid crystal medium composition between the upper and lower substrates to form a panel; and

(4) applying ultraviolet light having a wavelength of 300-380 nm to irradiate the panel in a direction from the upper substrate so that the polymerizable monomer contained in the liquid crystal medium composition is caused by the irradiation of the ultraviolet light having a wavelength of 300-380 nm to polymerize thereby achieving the purposes of alignment.

Step (1) further comprises a sub-step (1.1) of manufacturing the upper and lower substrates, which comprises providing upper and lower glass substrates, forming a black matrix, R, G, B pixels, substrates spacers, common electrode, and a coated alignment layer on the upper glass substrate so as to form the upper substrate; forming a TFT array, ITO pixel electrodes, common electrode, and a coated alignment layer on the lower glass substrate; the alignment layers being made of an alignment material of polyimide.

The efficacy of the present invention is that the present invention provides a liquid crystal medium composition, which is added with a sensitizer that has strong absorption of ultraviolet light having a wavelength ranging from 300-380 nm. The sensitizer reacts with a polymerizable monomer to form an exciplex that transfers energy absorbed thereby to the polymerizable monomer to cause polymerization thereof so as to have reactive wavelength of the polymerizable monomer shifted toward a longer wavelength (300-380 nm), making the efficiency of polymerization heightened and homogeneity of polymer so formed improved. A liquid crystal display that is manufactured by using the liquid crystal medium composition may be irradiated by ultraviolet light of wavelength ranging from 300-380 nm, so that absorption wavelength band of the liquid crystal material can be avoided, damage to the liquid crystal material and the alignment material of polyimide caused by ultraviolet light can be reduced, efficiency and homogeneity of reaction of the polymerizable monomer can be heightened, the alignment effect of panel can be improved, and thus the quality and lifespan of the panel are enhanced, making it possible to realize stable mass production and manufacture liquid crystal display with high reliability.

### DETAILED DESCRIPTION OF THE PREFERRED EMBODIMENTS

The present invention provides a liquid crystal medium composition,

which comprises: a liquid crystal material, a polymerizable monomer, a stabilizer, and a sensitizer. The sensitizer shows strong absorbance of ultraviolet light having wavelength between 300-380 nm. The sensitizer reacts with the polymerizable monomer to form an exciplex that transfers energy absorbed thereby to the polymerizable monomer to cause polymerization of the polymerizable monomer. The sensitizer is composed of a polycyclic aromatic hydrocarbon composed of a plurality of benzene rings linked with substituted moieties.

The sensitizer comprises at least one represented by the following formulas:

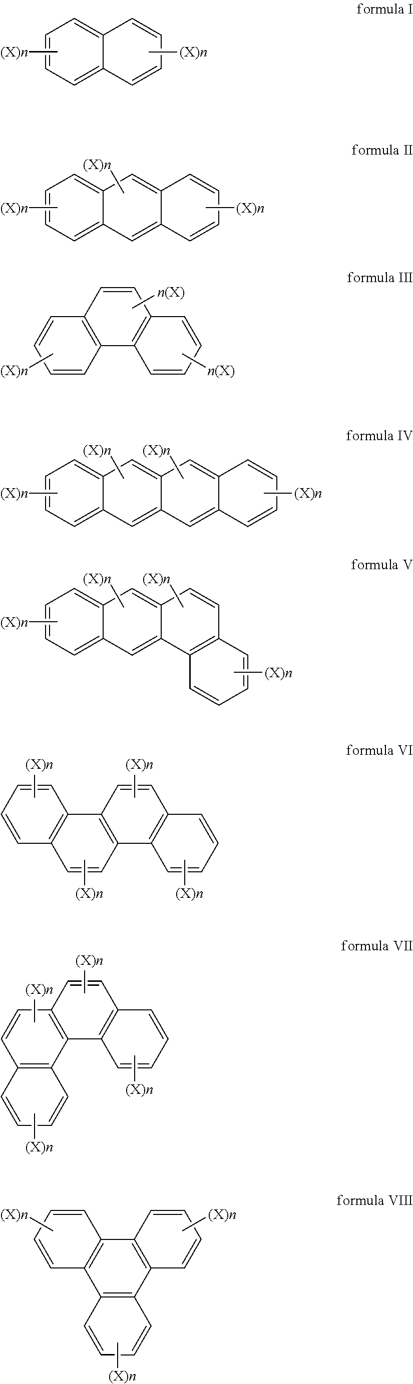

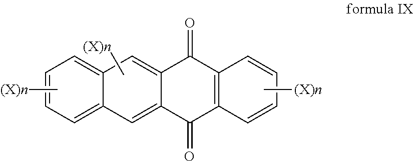

wherein X represents the substituted moieties linked to the rings; n is an integral of 1-4. In the above formula, (X)ₙ is linked to the rings in a non-fixed linking manner, indicating the position of (X)ₙ in the ring can be such as to link to any position, and also the number thereof is not limited to one and one or more of equivalent positions are provided with (X)ₙ. In the formula illustrated in Formula I to IX, the value of n in any of the formulas can being identical or different. If n>1, then it indicates that the individual ring structure has a plurality of substituted moieties X which are identical or different. The substituted moiety represented by X is: —H, —F, —Cl, —Br, —I, —CN, —NO₂, —R, —O—R, —CO—R, —OCO—R, —COO—R, or —(OCH₂CH₂)ₙ₁CH₃. R represents a C1-12 linear or branched alkyl and n1 is an integral of 1-5.

The sensitizer shows similar characteristics in chemical structure by having large π conjugated system. Generally, in a given range, the larger the conjugated system is, the longer the wavelength that can be absorbed will be. A substance having a large conjugated system, such as naphthalene, shows a strong absorption spectrum in the range of 240-320 nm and anthracene has a strong absorption spectrum in the range of 300-360 nm. The amount of sensitizer added is 5 ppm to 1000 ppm based on the total weight of the liquid crystal medium composition. The sensitizer can be used individually or several sensitizers used in combination.

The liquid crystal material comprises at least one liquid crystal molecule represented by the following formula:

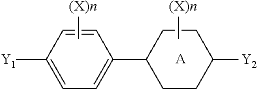

wherein

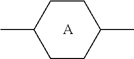

represents

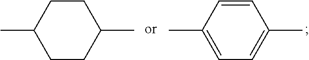

X represents substituted moieties linked to the rings, n is an integral of 1-4; n values in any of the above formulas are identical or different; n>1 indicates the individual ring structure has a plurality of substituted moieties X which are identical or different; the substituted moiety represented by X is: —H, —F, —Cl, —Br, —I, —CN, or —NO₂; Y₁ and Y₂ are —R, —O—R, —CO—R, —OCO—R, —COO—R, or —(OCH₂CH₂)ₙ₁CH₃; R represents a C1-12 linear or branched alkyl; n1 is an integral of 1-5; and Y₁ and Y₂ are identical or different.

The polymerizable monomer comprises at least one polymerizable molecule represented by the following formula:

P₁-L₁-X-L₂P₂

wherein P₁ and P₂ represent polymerizable moieties which, being identical or different, are methacrylate, acrylate, ethenyl, ethyleneoxy, or epoxy groups; L₁ and L₂ represent linking moieties which, being identical or different, are —C—C—, —O—, —COO—, —OCO—, —CH₂O—, —OCH₂O—, —O(CH₂)₂O—, —COCH₂—, or methylenyl; X represents a core moiety which is

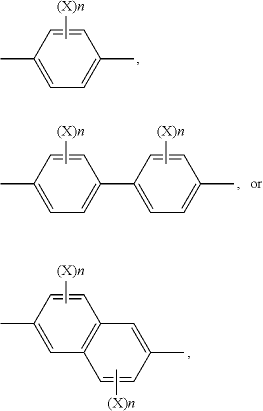

wherein X represents a substituted moiety linked to the ring structure; n is an integral of 1-4; n values in any of the above formulas are identical or different; n>1 indicates the individual ring structure has a plurality of substituted moieties X which are identical or different; the substituted moiety represented by X is: —H, —F, —Cl, —Br, —I, —CN, or —NO₂.

The stabilizer comprises at least one molecule represented by the following formula:

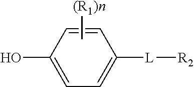

wherein R₁ represents a C1-9 linear or branched alkyl; n is an integral of 1-4; n>1 indicates the individual ring structure has a plurality of substituted moieties R₁ which are identical or different; R₂ represents a C1-36 linear or branched alkyl; and L is —C—C—, —O—, —COO—, —OCO—, —CH₂O—, —OCH₂O—, —O(CH₂)₂O—, —COCH₂— or methylenyl.

The liquid crystal medium composition according to the present invention uses the sensitizer to have the polymerizable monomer contained therein to carry out polymerization reaction under irradiation of ultraviolet light having a wavelength of 300-380 nm. In other words, when ultraviolet light is used to cause internal polymerization reaction, ultraviolet light of wavelength 300-380 nm can be adopted for ultraviolet light within this wavelength band is rarely or not absorbed by the liquid crystal material thereby alleviating the damage caused on the liquid crystal material. The sensitizer shows a strong absorbance with respect to ultraviolet light of this wavelength band and may form an exciplex with the polymerizable monomer in this wavelength band to transfer energy absorbed thereby to the polymerizable monomer and cause polymerization of the polymerizable monomer so as to achieve the purposes of shifting the reactive wavelength of the polymerizable monomer toward a longer wavelength (the reactive wavelength being shifted from 200-300 nm to 300-380 nm). The sensitizer itself does not participate in any chemical reaction and only provides the function of transferring energy so as not to cause any negative effect on the liquid crystal medium composition and product of liquid crystal display so manufactured.

The liquid crystal medium composition of the present invention is applicable to a liquid crystal display. A liquid crystal display that uses the above discussed liquid crystal medium composition according to the present invention comprises: upper and a lower substrate that are arranged parallel to each other and a liquid crystal medium composition arranged between the upper and lower substrates. The upper substrate comprises an upper glass substrate and a black matrix, R, G, B pixels, substrate spacers, and common electrode formed on a surface thereof that faces the lower substrate. The lower substrate comprises a lower glass substrate and data lines, gate lines, a TFT array, ITO pixel electrodes, and common electrodes formed on a surface thereof that faces the upper substrate. Surfaces of the upper and lower substrates that face each other are coated with alignment films. The alignment films are formed of an alignment material of polyimide.

As mentioned above, the liquid crystal medium composition is added with the sensitizer, which shows strong absorbance of ultraviolet light having a wavelength of 300-380 nm. Through irradiation of ultraviolet light (of which wavelength is 300-380 nm) corresponding to the liquid crystal medium composition, the sensitizer absorbs energy of the wavelength band and transfers the energy to the polymerizable monomer to cause polymerization of the polymerizable monomer. Result and homogeneity of reaction are heightened and the polymer so formed is homogeneous thereby improving the alignment effect of liquid crystal display panel can be improved and thus enhancing the quality and lifespan of the panel, making it possible to realize stable mass production and manufacture liquid crystal displays of high reliability.

The liquid crystal medium composition comprises: a liquid crystal material, a polymerizable monomer, a stabilizer, and a sensitizer, wherein the sensitizer shows strong absorbance of ultraviolet light having wavelength between 300-380 nm and is composed of a polycyclic aromatic hydrocarbon composed of a plurality of benzene rings linked with substituted moieties.

A method for manufacturing the liquid crystal display according to the present invention comprises the following steps:

Step 1: providing upper and lower substrates and a liquid crystal medium composition, the liquid crystal medium composition being the liquid crystal medium composition according to the present invention;

The step further comprises Sub-step 1.1: of manufacturing upper and lower substrates: providing upper and lower glass substrates, forming a black matrix, R, G, B pixels, substrates spacers, common electrode, and a coated alignment layer on the upper glass substrate so as to form the upper substrate; forming data lines, gate lines, a TFT array, ITO pixel electrodes, common electrode, and a coated alignment layer on the lower glass substrate, the alignment layers being made of an alignment material of polyimide.

Step 2: dropping the liquid crystal medium composition on the lower substrate, wherein the liquid crystal medium composition is dropped onto the surface of the lower substrate that comprises an alignment layer by applying ODF (One Drop Filling) process. In this step, seal resin is first applied to the lower substrate and the liquid crystal medium composition is dropped inside the seal resin.

Step 3: mounting the upper substrate to the lower substrate in a manner of being set in parallel to the lower substrate so as to interpose the liquid crystal medium composition between the upper and lower substrates to form a panel. In the assembling, the upper substrate is mounted to the lower substrate by having the surface thereof that comprises an alignment layer opposing the lower substrate and thus the liquid crystal medium composition is set between the upper and lower substrates. The seal resin is then cured to strengthen the panel structure so formed.

Step 4: applying ultraviolet light having a wavelength of 300-380 nm to irradiate the panel in a direction from the upper substrate so that the polymerizable monomer contained in the liquid crystal medium composition is caused by the irradiation of the ultraviolet light having a wavelength of 300-380 nm to polymerize thereby achieving the purposes of alignment. Preferably, ultraviolet light having a wavelength of 310-380 nm is used to irradiate the panel. Through the irradiation of the ultraviolet light, the sensitizer contained in the liquid crystal medium composition absorbs the ultraviolet light so that the sensitizer forms an exciplex with the polymerizable monomer to transfer energy absorbed thereby to the polymerizable monomer and cause polymerization of the polymerizable monomer in the wavelength ranging 300-380 nm. The efficiency of polymerization is high and homogeneity of polymer so formed is excellent. The result of alignment of the panel is improved. Further, since ultraviolet light of wavelength ranging from 300-380 nm is used, absorption wavelength band of the liquid crystal material can be avoided and damage to the liquid crystal material and the alignment layers caused by ultraviolet of this band can be significantly reduced. Thus, the quality and lifespan of the liquid crystal display panel are enhanced. Stable mass production can be realized. The liquid crystal display manufactured with the method can be of high reliability.

Examples are given below to describe the way of practicing the present invention.

### Example 1

Upper and lower substrates are manufactured. The lower substrate is provided with data lines, gate lines, a TFT array, ITO pixel electrodes, and common electrodes and has a substrate surface that is coated with an alignment layer. The upper substrate is provided with a black matrix and R, G, B pixels, substrates spacers, and common electrode and has a surface that is similarly coated with an alignment layer. A negative liquid crystal is used and is mixed with a polymerizable monomer, a sensitizer, and a stabilizer to form a liquid crystal medium composition. The sensitizer has a structure of the following formula:

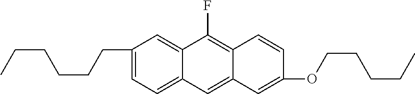 [SMILES: CCCCCCc1ccc2cc3cc(OCCCCC)ccc3c(F)c2c1]

The amount of the sensitizer added in the liquid crystal medium composition is 70 ppm. The upper and lower substrates are assembled with the liquid crystal medium composition to form a panel, and subsequently, the panel is irradiated with ultraviolet light having a wavelength of 310-380 nm in a direction from the upper substrate to cause polymerization of the polymerizable monomer to form a polymer for achieving the purposes of alignment.

### Examples 2-7

These examples are similar to Example 1, except that the molecular structure and contents of the sensitizer and the wavelength range of ultraviolet are different, which are listed in the following Table 1.

TABLE 1
Molecular Structure and Contents of Sensitizer and Wavelength range of Ultraviolet of Examples 2-7

| | | Contents | UV |
|---|---|---|---|
| | Molecular Structure of Sensitizer (A) | of A | Wavelength |
| Ex 2 | 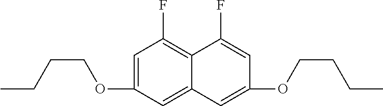 [SMILES: CCCCOc1cc(F)c2c(F)cc(OCCCC)cc2c1] | 100 ppm | 300-360 nm |
| Ex 3 | 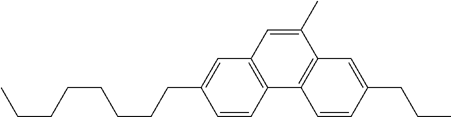 [SMILES: CCCCCCCCc1ccc2c(c1)cc(C)c1cc(CCC)ccc12] | 80 ppm | 300-380 nm |
| Ex 4 | 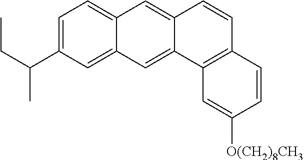 | 70 ppm | 310-380 nm |
| Ex 5 | 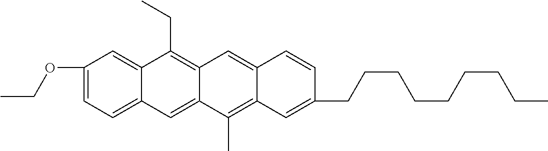 [SMILES: CCCCCCCCCc1ccc2cc3c(CC)c4cc(OCC)ccc4cc3c(C)c2c1] | 60 ppm | 320-380 nm |
| Ex6 | 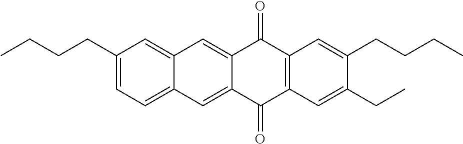 [SMILES: CCCCc1ccc2cc3c(cc2c1)C(=O)c1cc(CCCC)c(CC)cc1C3=O] | 40 ppm | 300-380 nm |
| Ex 7 | 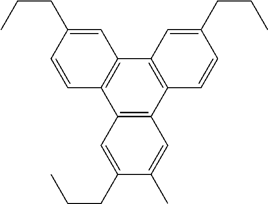 [SMILES: CCCc1ccc2c(c1)c1cc(CCC)ccc1c1cc(CCC)c(C)cc21] | 50 ppm | 300-380 nm |

In summary, the present invention provides a liquid crystal medium composition that through addition of a sensitizer, makes the reactive wavelength of a polymerizable monomer shifting from 200-300 nm toward 300-380 nm, avoiding the absorption band of the liquid crystal material and heightening the efficiency and homogeneity of reaction of the polymerizable monomer. A liquid crystal display manufactured by using the liquid crystal medium composition uses ultraviolet light in the wavelength range of 300-380 nm, thereby avoiding the absorption band of liquid crystal material, greatly alleviating damage of the liquid crystal material and the alignment material of polyimide of the liquid crystal display caused by ultraviolet light, improving the quality and lifespan of the liquid crystal display panel, realizing stable mass production, and making the liquid crystal display so manufactured of high reliability.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A liquid crystal medium composition, comprising: a liquid crystal material, a polymerizable monomer, a stabilizer, and a sensitizer, wherein the sensitizer shows strong absorbance of ultraviolet light having wavelength between 300-380 nm and is composed of a polycyclic aromatic hydrocarbon composed of a plurality of benzene rings linked with substituted moieties.

2. The liquid crystal medium composition as claimed in claim 1, wherein the sensitizer comprises at least one represented by the following formulas: 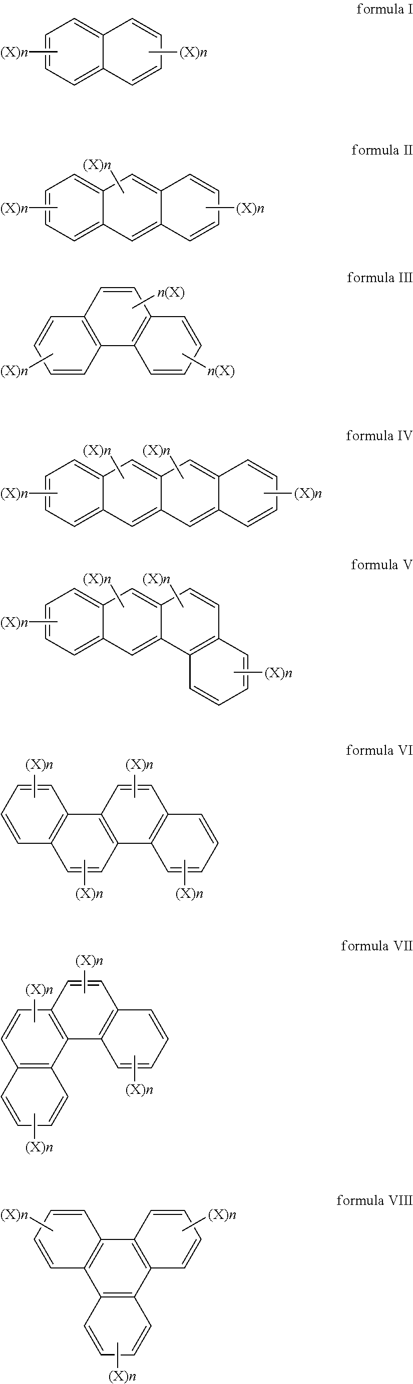 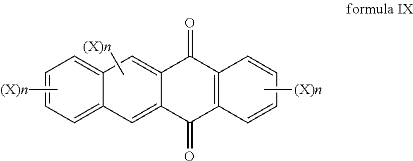
wherein X represents the substituted moieties linked to the rings; n is an integral of 1-4; n values in any of the above formulas are identical or different; n>1 indicates the individual ring structure has a plurality of substituted moieties X which are identical or different; the substituted moiety represented by X is: —H, —F, —Cl, —Br, —I, —CN, —NO₂, —R, —O—R, —CO—R, —OCO—R, —COO—R, or —(OCH₂CH₂)ₙ₁CH₃; R represents a C1-12 linear or branched alkyl; and n1 is an integral of 1-5.

3. The liquid crystal medium composition as claimed in claim 1, wherein the sensitizer is added in an amount of 5 ppm to 1000 ppm based on the total weight of the liquid crystal medium composition.

4. The liquid crystal medium composition as claimed in claim 1, wherein the polymerizable monomer contained in the liquid crystal medium composition is polymerized through the sensitizer by means of irradiation of ultraviolet light having a wavelength of 300-380 nm.

5. The liquid crystal medium composition as claimed in claim 1, wherein the liquid crystal material comprises at least one liquid crystal molecule represented by the following formula: 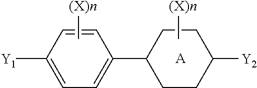
wherein 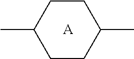
represents 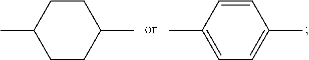
X represents substituted moieties linked to the rings, n is an integral of 1-4; n values in any of the above formulas are identical or different; n>1 indicates the individual ring structure has a plurality of substituted moieties X which are identical or different; the substituted moiety represented by X is: —H, —F, —Cl, —Br, —I, —CN, or —NO₂; Y₁ and Y₂ are —R, —O—R, —CO—R, —OCO—R, —COO—R, or —(OCH₂CH₂)ₙ₁CH₃; R represents a C1-12 linear or branched alkyl; n1 is an integral of 1-5; and Y₁ and Y₂ are identical or different.

6. The liquid crystal medium composition as claimed in claim 1, wherein the polymerizable monomer comprises at least one polymerizable molecule represented by the following formula:
P₁-L₁-X-L₂-P₂
wherein P₁ and P₂ represent polymerizable moieties which, being identical or different, are methacrylate, acrylate, ethenyl, ethyleneoxy, or epoxy groups; L₁ and L₂ represent linking moieties which, being identical or different, are —C—C—, —O—, —COO—, —OCO—, —CH₂O—, —COH₂O—, —O(CH₂)₂O—, —COCH₂—, or methylenyl; X represents a core moiety which is 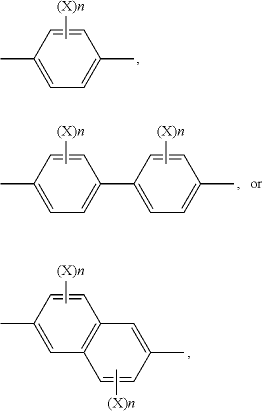
wherein X represents a substituted moiety linked to the ring structure; n is an integral of 1-4; n values in any of the above formulas are identical or different; n>1 indicates the individual ring structure has a plurality of substituted moieties X which are identical or different; the substituted moiety represented by X is: —H, —F, —Cl, —Br, —I, —CN, or —NO₂.

7. The liquid crystal medium composition as claimed in claim 1, wherein the stabilizer comprises at least one molecule represented by the following formula: 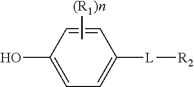
wherein R₁ represents a C1-9 linear or branched alkyl; n is an integral of 1-4; n>1 indicates the individual ring structure has a plurality of substituted moieties R₁ which are identical or different; R₂ represents a C1-36 linear or branched alkyl; and L is —C—C—, —O—, —COO—, —COO—, —CH₂O—, —OCH₂O—, —O(CH₂)₂O—, —COCH₂— or methylenyl.

8. A liquid crystal display, comprising: upper and a lower substrate that are arranged parallel to each other and a liquid crystal medium composition arranged between the upper and lower substrates, the liquid crystal medium composition comprising: a liquid crystal material, a polymerizable monomer, a stabilizer, and a sensitizer, wherein the sensitizer shows strong absorbance of ultraviolet light having wavelength between 300-380 nm and is composed of a polycyclic aromatic hydrocarbon composed of a plurality of benzene rings linked with substituted moieties.

9. The liquid crystal display as claimed in claim 8, wherein the sensitizer comprises at least one represented by the following formulas: 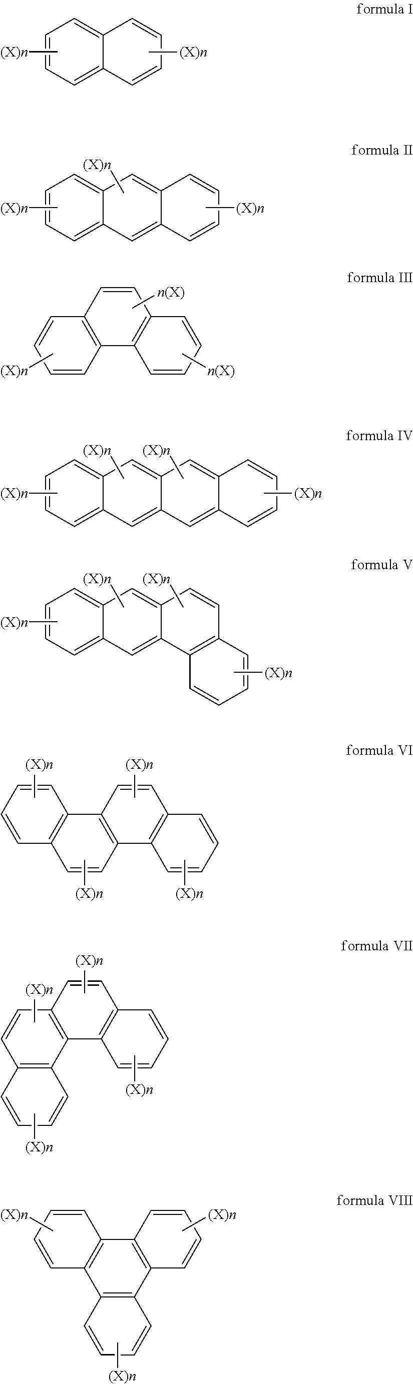 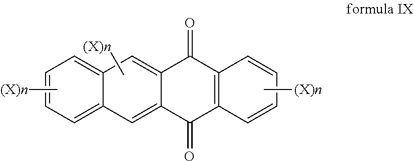
wherein X represents the substituted moieties linked to the rings; n is an integral of 1-4; n values in any of the above formulas are identical or different; n>1 indicates the individual ring structure has a plurality of substituted moieties X which are identical or different; the substituted moiety represented by X is: —H, —F, —Cl, —Br, —I, —CN, —NO₂, —R, —O—R, —CO—R, —OCO—R, —COO—R, or —(OCH₂CH₂)ₙ₁CH₃; R represents a C1-12 linear or branched alkyl; and n1 is an integral of 1-5.

10. The liquid crystal display as claimed in claim 8, wherein the polymerizable monomer contained in the liquid crystal medium composition is polymerized through the sensitizer by means of irradiation of ultraviolet light having a wavelength of 300-380 nm; the sensitizer is added in an amount of 5 ppm to 1000 ppm based on the total weight of the liquid crystal medium composition.

11. The liquid crystal display as claimed in claim 8, wherein the liquid crystal material comprises at least one liquid crystal molecule represented by the following formula: 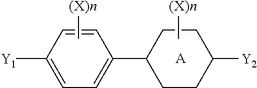
wherein 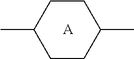
represents 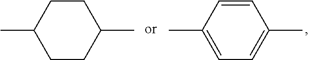
X represents substituted moieties linked to the rings, n is an integral of 1-4; n values in any of the above formulas are identical or different; n>1 indicates the individual ring structure has a plurality of substituted moieties X which are identical or different; the substituted moiety represented by X is: —H, —F, —Cl, —Br, —I, —CN, or —NO₂; Y₁ and Y₂ are —R, —O—R, —CO—R, —OCO—R, —COO—R, or —(OCH₂CH₂)ₙ₁CH₃; R represents a C1-12 linear or branched alkyl; n1 is an integral of 1-5; and Y₁ and Y₂ are identical or different; wherein the polymerizable monomer comprises at least one polymerizable molecule represented by the following formula:
P₁-L₁-X-L₂-P₂
wherein P₁ and P₂ represent polymerizable moieties which, being identical or different, are methacrylate, acrylate, ethenyl, ethyleneoxy, or epoxy groups; L₁ and L₂ represent linking moieties which, being identical or different, are —C—C—, —O—, —COO—, —OCO—, —CH₂O—, —OCH₂O—, —O(CH₂)₂O—, —COCH₂—, or methylenyl; X represents a core moiety which is 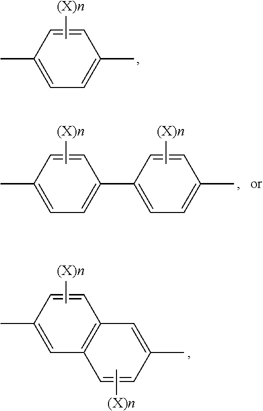
wherein X represents a substituted moiety linked to the ring structure; n is an integral of 1-4; n values in any of the above formulas are identical or different; n>1 indicates the individual ring structure has a plurality of substituted moieties X which are identical or different; the substituted moiety represented by X is: —H, —F, —Cl, —Br, —I, —CN, or —NO₂;
wherein the stabilizer comprises at least one molecule represented by the following formula: 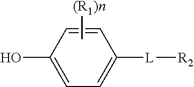
wherein R₁ represents a C1-9 linear or branched alkyl; n is an integral of 1-4; n>1 indicates the individual ring structure has a plurality of substituted moieties R₁ which are identical or different; R₂ represents a C1-36 linear or branched alkyl; and L is —C—C—, —O—, —COO—, —OCO—, —CH₂O—, —OCH₂O—, —O(CH₂)₂O—, —COCH₂— or methylenyl.

12. The liquid crystal display as claimed in claim 8, wherein the upper substrate comprises an upper glass substrate and a black matrix, R, G, B pixels, substrate spacers, and common electrode formed on a surface thereof that faces the lower substrate, the lower substrate comprising a lower glass substrate and a TFT array, ITO pixel electrodes, and common electrodes formed on a surface thereof that faces the upper substrate, surfaces of the upper and lower substrates that face each other being coated with alignment films, which are formed of an alignment material of polyimide.

13. A method for manufacturing a liquid crystal display according to claim 8, comprising the following steps:
(1) providing upper and lower substrates and the liquid crystal medium composition;
(2) dropping the liquid crystal medium composition on the lower substrate;
(3) mounting the upper substrate to the lower substrate in a manner of being set in parallel to the lower substrate so as to interpose the liquid crystal medium composition between the upper and lower substrates to form a panel; and
(4) applying ultraviolet light having a wavelength of 300-380 nm to irradiate the panel in a direction from the upper substrate so that the polymerizable monomer contained in the liquid crystal medium composition is caused by the irradiation of the ultraviolet light having a wavelength of 300-380 nm to polymerize thereby achieving the purposes of alignment.

14. The method for manufacturing a liquid crystal display as claimed in claim 13, wherein step (1) further comprises a sub-step (1.1) of manufacturing the upper and lower substrates, which comprises providing upper and lower glass substrates, forming a black matrix, R, G, B pixels, substrates spacers, common electrode, and a coated alignment layer on the upper glass substrate so as to form the upper substrate; forming a TFT array, ITO pixel electrodes, common electrode, and a coated alignment layer on the lower glass substrate; the alignment layers being made of an alignment material of polyimide.
